(19) United States
(12) Patent Application Publication
(10) Pub. No.: US 2011/0310189 A1
(43) Pub. Date: Dec. 22, 2011

(54) RECORDING APPARATUS AND INK CARTRIDGE

(75) Inventors: Tomohiro Kanbe, Nagoya-shi (JP); Hirotake Nakamura, Nagoya-shi (JP)

(73) Assignee: Brother Kogyo Kabushiki Kaisha, Nagoya-shi (JP)

(21) Appl. No.: 12/893,529

(22) Filed: Sep. 29, 2010

(30) Foreign Application Priority Data
Jun. 17, 2010 (EP) 10166395.3

(51) Int. Cl. B41J 2/175

(52) U.S. Cl. 347/86

(57) ABSTRACT

An ink cartridge includes a particular wall, a particular edge, a first detection portion positioned at the particular edge, a second detection portion positioned at the particular edge, a third detection portion extending from the particular wall in a particular direction, an ink supply portion positioned at the particular wall, and a remaining amount detection portion positioned at the particular wall. Each of the first detection portion and the second detection portion is positioned further from the particular edge in the particular direction than the ink supply portion is positioned from the particular edge. The third detection portion is positioned further from the particular edge in the particular direction than the remaining amount detection portion is positioned from the particular edge and the third detection portion is positioned closer to the particular edge than the ink supply portion.

### CROSS-REFERENCE TO RELATED APPLICATIONS

The present application claims priority to and the benefit of European Patent Application No. 10 166 395.3, which was filed on Jun. 17, 2010, the disclosure of which is incorporated herein by reference in its entirety.

### BACKGROUND OF THE INVENTION

1. Field of the Invention

The present invention relates to a recording apparatus having a cartridge installation portion installing therein an ink cartridge, and an ink cartridge.

2. Description of Related Art

In a known tube supply-type image recording apparatus, an ink cartridge is located outside a carriage mounted with a recording head, and this ink cartridge and the recording head are connected to each other via a tube. This ink cartridge is installed into a cartridge installation portion, which has an opening in, for example, the front surface of an apparatus body, in the horizontal direction via the opening. This cartridge installation portion accommodates the ink cartridge to be attachable thereto and detachable therefrom. With the ink cartridge installed in the cartridge installation portion, an ink channel extending from the ink cartridge to the recording head is formed. Through this ink channel, ink is supplied to the recording head from the ink cartridge.

A detected portion or a remaining amount detection unit provided to the ink cartridge in accordance with a variety of purposes is desired to be reliably detected by a sensor provided to the cartridge installation portion.

### SUMMARY OF THE INVENTION

The present invention has been made in the light of the above-described circumferences, and it is an object of the present invention to provide an ink cartridge and a recording apparatus achieving the object of reliably detecting the installation for the ink cartridge and/or reliably detecting the remaining amount of ink.

According to an embodiment of the invention, an ink cartridge comprising a particular wall, a particular edge, an ink chamber configured to store ink therein at the particular wall, a first detection portion positioned at the particular edge of the ink cartridge, a second detection portion positioned at the particular edge of the ink cartridge, a third detection portion extending from the particular wall in a particular direction and positioned between the first detection portion and the second detection portion in a direction perpendicular to the particular direction, an ink supply portion positioned at the particular wall and configured to supply the ink stored in the ink chamber to an exterior of the ink chamber, and a remaining amount detection portion positioned at the particular wall between the first detection portion and the second detection portion in the direction perpendicular to the particular direction and configured to transition between a light-transmitting state and a light-blocking state based on an amount of the ink stored in the ink chamber. Each of the first detection portion and the second detection portion is positioned further from the particular edge in the particular direction than the ink supply portion is positioned from the particular edge, and the third detection portion is positioned further from the particular edge in the particular direction than the remaining amount detection portion is positioned from the particular edge and the third detection portion is positioned closer to the particular edge than the ink supply portion.

Accordingly to another embodiment of the invention, a recording apparatus comprising a cartridge installation portion configured to receive therein an ink cartridge such that the ink cartridge is inserted into the cartridge installation portion in an installation direction. The cartridge installation portion comprises a first sensor configured to output first detection information based on a detection of a first detection portion of the ink cartridge, a second sensor configured to output second detection information based on a detection of a second detection portion of the ink cartridge, and a third sensor configured to output third detection based on a detection of a third detection portion of the ink cartridge, and configured to detect a light-transmitting state of a remaining amount detection portion of the ink cartridge and to output fourth detection information based on the light-transmitting state of the remaining amount detection portion, and control means for performing a first process of determining a type of the ink cartridge based on the first detection information, the second detection information, and the third detection information, and for performing a second process of determining a remaining amount of an ink stored in an ink chamber of the ink cartridge based on the fourth detection information.

Other objects, features, and advantages will be apparent to persons of ordinary skill in the art from the following detailed description of the invention and the accompanying drawings.

### BRIEF DESCRIPTION OF DRAWINGS

For a more complete understanding of the present invention, needs satisfied thereby, and the objects, features, and advantages thereof, reference now is made to the following description taken in connection with the accompanying drawings.

FIG. 1 is a schematic cross-sectional view schematically illustrating an internal structure of a printer, including an ink supply device, according to an embodiment of the invention.

FIG. 2 is a perspective view illustrating an external configuration of an ink cartridge, according to an embodiment of the invention.

FIG. 3 is a vertical cross-sectional view illustrating an internal configuration of the ink cartridge, according to an embodiment of the invention.

FIG. 4 is a perspective view illustrating a configuration of a cartridge installation portion, according to an embodiment of the invention.

FIG. 5 is a front view of the cartridge installation portion, according to an embodiment of the invention.

FIG. 6 is a vertical cross-sectional view illustrating a state in which the ink cartridge is installed in the cartridge installation portion, according to an embodiment of the invention.

FIG. 7 is a block diagram illustrating a configuration of a control unit, according to an embodiment of the invention.

FIG. 8 is a cross-sectional view of the cartridge installation portion, illustrating a state immediately after the insertion of the ink cartridge into the cartridge installation portion, according to an embodiment of the invention.

FIG. 9 is a cross-sectional view of the cartridge installation portion, illustrating a state in which the ink cartridge is inserted into the cartridge installation portion and a rib of a first projection is detected, according to an embodiment of the invention.

FIG. 10 is a cross-sectional view of the cartridge installation portion, illustrating a state in which the ink cartridge is inserted into the cartridge installation portion and a rib of a slide member is detected, according to an embodiment of the invention.

FIG. 11 is a cross-sectional view of the cartridge installation portion, illustrating a state in which the ink cartridge, which includes a second projection having a long dimension, is inserted into the cartridge installation portion and the rib of the first projection is detected, according to an embodiment of the invention.

FIG. 12 is a cross-sectional view of the cartridge installation portion, illustrating a state in which the ink cartridge, which includes a detected element having a long dimension, is inserted into the cartridge installation portion and the rib of the first projection is detected, according to an embodiment of the invention.

FIGS. 13A and 13B show timing charts illustrating output signals from optical sensors, when the dimension of the detected element of the ink cartridge is short, according to an embodiment of the invention.

FIGS. 14A and 14B show timing charts illustrating output signals from the optical sensors, when the dimension of the detected element of the ink cartridge is long, according to an embodiment of the invention.

### DETAILED DESCRIPTION OF EMBODIMENTS OF THE INVENTION

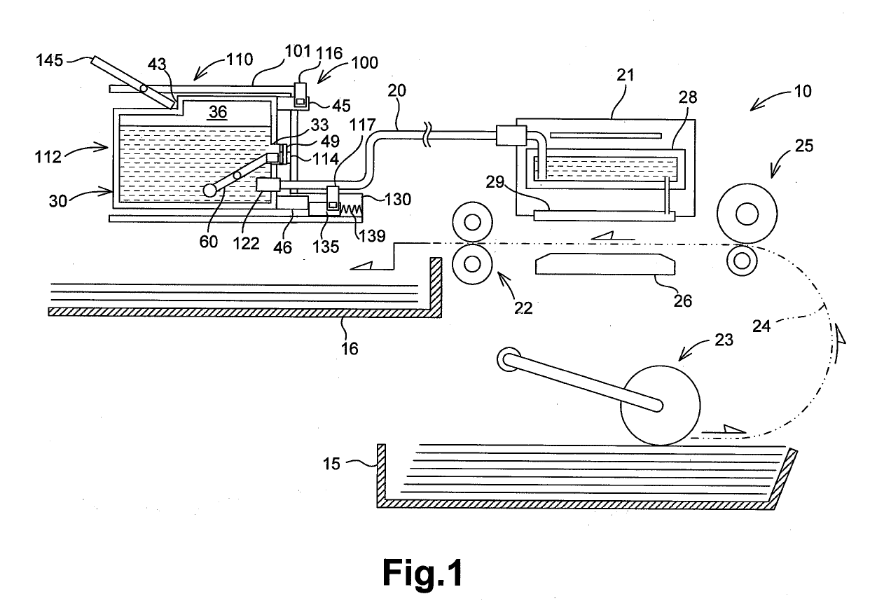

Embodiments of the present invention, and their features and advantages, may be understood by referring to FIGS. 1-14, like numerals being used for like corresponding parts in the various drawings. Embodiments of the invention, as described below, are merely exemplary embodiments, and the embodiments may be altered within the scope of the invention

As shown in FIG. 1, a printer 10 may be a recording apparatus for recording an image by selectively discharging ink droplets onto a recording sheet on the basis of an inkjet recording method. The printer 10 may comprise an ink supply device 100. The ink supply device 100 may comprise a cartridge installation portion 110. The cartridge installation portion 110 may be configured to receive an ink cartridge, e.g., ink cartridge 30, therein. The cartridge installation portion 110 also may have an opening 112 formed in one surface thereof and opening to an exterior of ink supply device 100. The ink cartridge 30 may be selectively inserted into and removed from the cartridge installation portion 110 via the opening 112.

The ink cartridge 30 may store ink usable in the printer 10. When the ink cartridge 30 is installed in the cartridge installation portion 110, the ink cartridge 30 may be connected to a recording head 21 by an ink tube 20. The recording head 21 may comprise a sub tank 28. The sub tank 28 may temporarily receive and store the ink supplied through the ink tube 20. In accordance with an inkjet recording method, the recording head 21 may selectively discharge, from a nozzle 29, the ink supplied from the sub tank 28.

A recording sheet fed and conveyed from a sheet-feeding tray 15 to a conveying path 24 by a sheet-feeding roller 23 may be conveyed onto a platen 26 by a conveying roller pair 25. The recording head 21 selectively may discharge the ink onto the recording sheet passing over the platen 26. Thereby, an image may be recorded on the recording sheet. The recording sheet having passed the platen 26 may be discharged by a discharging roller pair 22 onto a sheet-discharging tray 16, wherein the sheet-discharging tray 16 is positioned on the most downstream side of the conveying path 24.

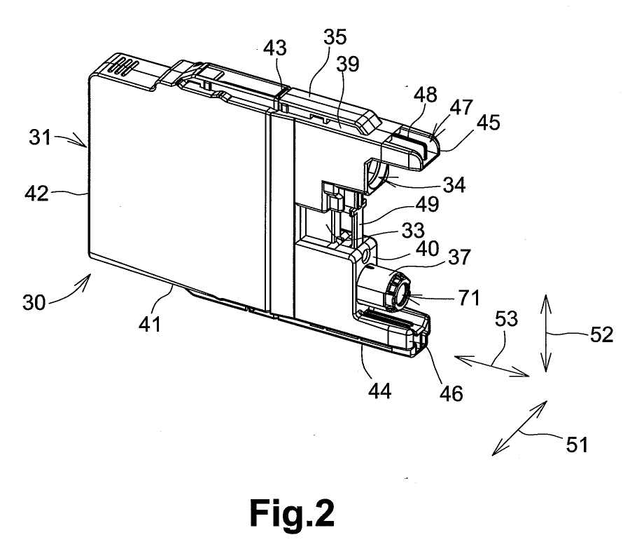

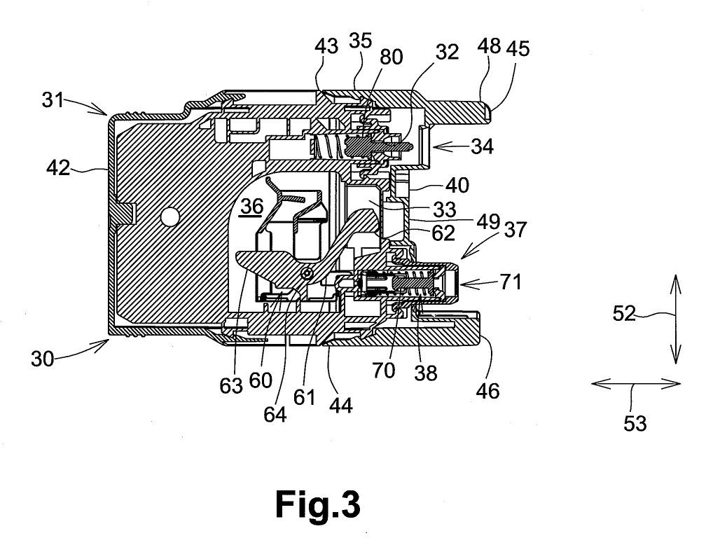

FIGS. 2 and 3 show an ink cartridge 30, which in an embodiment of the invention, may be a container for storing therein ink. An ink chamber 36 may be formed in the space inside the ink cartridge 30 therein, and ink chamber 36 may store ink therein. The ink chamber 36 may be formed by a body 31 forming the exterior of the ink cartridge 30, or may be formed by a member separate from the body 31. The ink cartridge 30 may be selectively inserted into and removed from the cartridge installation portion 110 along directions indicated by arrows 50 (hereinafter interchangeably referred to as “the insertion and removal directions 50”). FIGS. 2 and 3 show ink cartridge 30 positioned in what will hereinafter be interchangeably referred to as a “standing state,” i.e., a state in which a surface on the lower side in the drawings may form a bottom surface and a surface on the upper side in the drawings may form an upper surface. The ink cartridge 30 may be inserted into and removed from the cartridge installation portion 110 in the standing state.

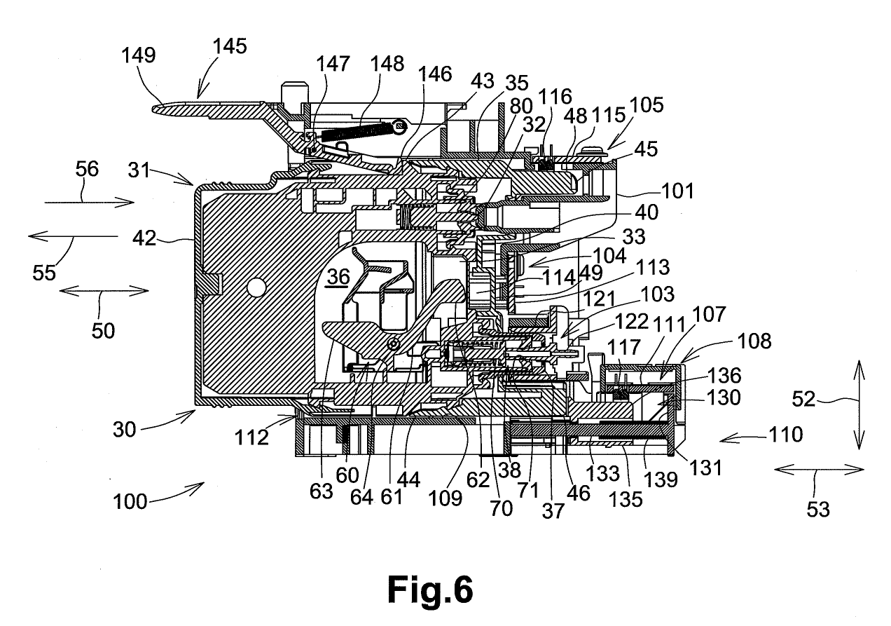

In an embodiment of the invention, this standing state corresponds to an installation posture, although other embodiments may have other states of ink cartridge 30 as installation postures. The direction in which the ink cartridge 30 is installed into the cartridge installation portion 110 may be an installation direction 56, e.g., as shown in FIG. 6, and the direction in which the ink cartridge 30 is removed from the cartridge installation portion 110 may be a removal direction 55, e.g., as shown in FIG. 6. Referring again to FIGS. 2 and 3, height directions 52 in the standing state may correspond to the direction in which the force of gravity operates, and the opposite directions. In an embodiment of the invention as described herein, the ink cartridge 30 may be inserted into the cartridge installation portion 110 along the insertion and removal directions 50, and may be removed from the cartridge installation portion 110 along the insertion and removal directions 50.

The ink cartridge 30 may comprise the body 31, which may have a substantially rectangular parallelepiped shape. The body 31 may have a flattened shape, thinner in width directions, 51 e.g., left and right directions as shown in FIGS. 2 and 3, and wider in the height directions 52 and depth directions 53, e.g., front and rear directions as shown in FIGS. 2 and 3, than in the width directions 51. A wall of the body 31 located on the front side in the installation direction 56 when the ink cartridge 30 is installed into the cartridge installation portion 110 may be a front wall 40, and a wall of the body 31 located on the rear side in the installation direction 56 may be a rear wall 42. The front wall 40 and the rear wall 42 may face each other in the insertion and removal directions 50. The front wall 40 and the rear wall 42 respectively may be demarcated by four walls, which may include a pair of side walls extending in the insertion and removal directions 50, an upper wall 39 connecting the side walls, the front wall 40, and the rear wall 42. Upper wall 39 may extend from the upper end of the front wall 40 to the upper end of the rear wall 42, and a lower wall 41 may extend from the lower end of the front wall 40 to the lower end of the rear wall 42. The insertion and removal directions 50 may be substantially parallel to the depth directions 53. The front wall 40 may correspond to a front surface of the ink cartridge 30. The rear wall 42 may correspond to a rear surface of the ink cartridge 30. The upper wall 39 may correspond to an upper surface of the ink cartridge 30. The lower wall 41 may correspond to a bottom surface of the ink cartridge 30.

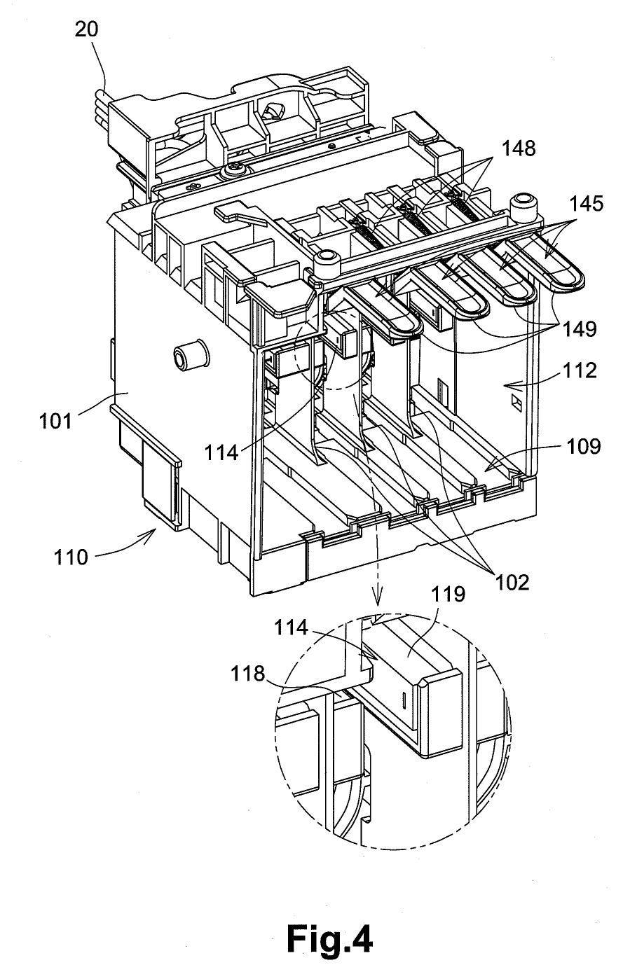

A portion of the front wall 40 of the body 31 near the center thereof in the height directions 52 may be provided with a remaining amount detection unit 33. The remaining amount detection unit 33 may be located further rearward 56 than the leading end of a rib 48 of a first projection 45, the leading end of a second projection 46, and a detected element 49, in the installation direction 56. First projection 45, second projection 46, and detected element 49 will be discussed in more detail further herein. The remaining amount detection unit 33 may have a substantially box shape having an opening in one side thereof. The opening in remaining amount detection unit 33 may place remaining amount detection unit 33 in fluid communication with the ink chamber 36. Further, the remaining amount detection unit 33 may comprise a pair of walls formed of a light-transmissive resin. As shown in FIG. 4, these walls may allow light emitted from an optical sensor 114 to be transmitted therethrough.

As shown in FIG. 3, a hollow space may be formed between a pair of left and right walls of the remaining amount detection unit 33, and ink may be stored therein. An indicator portion 62 of a sensor arm 60 may be positioned between the pair of left and right walls of the remaining amount detection unit 33. The sensor arm 60 may comprise the indicator portion 62 and a floating portion 63, respectively positioned at opposite ends of a plate-like arm body 61. In the ink chamber 36, the sensor arm 60 may be rotatably supported by a support shaft 64 extending along the width directions 51. The sensor arm 60 may shift from a lower posture in which the indicator portion 62 is located on the lower side in the gravity direction of the remaining amount detection unit 33 and an upper posture in which the indicator portion 62 is located on the upper side in the gravity direction of the remaining amount detection unit 33, in accordance with an amount of ink present in the ink chamber 36. FIG. 3 illustrates a state in which at least a predetermined amount of ink is present in ink chamber 36, and the indicator portion 62 takes the lower posture.

Ink cartridge 30 may be in a state in which the ink cartridge 30 is installed in the cartridge installation portion 110, the remaining amount detection unit 33 may shift between a state of allowing the transmission of a predetermined amount or more of infrared light from the optical sensor 114 provided to the cartridge installation portion 110, e.g., a transmission state, and a state of blocking or attenuating the infrared light to be less than the predetermined amount, e.g., a blocking state. If the indicator portion 62 takes the upper posture, the remaining amount detection unit 33 may allow the transmission of the infrared light. If the indicator portion 62 takes the lower posture, the remaining amount detection unit 33 may block, deflect, or attenuate the infrared light. In accordance with the light-transmitting state of the remaining amount detection unit 33, the remaining ink amount in the ink chamber 36 may be determined to have decreased to be less than the predetermined amount.

The remaining amount detection unit 33 may omit the sensor arm 60 in an embodiment of the invention. In the optical sensor 114, a light-emitting element 118 and a light-receiving element 119 may face each other in the horizontal direction, as described in more detail herein. Further, the light emitted from the light-emitting element 118 may be received by the light-receiving element 119. Further, the configuration may be such that the infrared light emitted from the light-emitting element 118 may be blocked, deflected, or attenuated in a state in which the ink is present in the remaining amount detection unit 33, and that a predetermined amount or more of the infrared light emitted from the light-emitting element 118 may be transmitted in a state in which the ink is absent in the remaining amount detection unit 33.

In another embodiment of the invention, the remaining amount detection unit 33 may be formed by a soft film. That is, the configuration may be such that, when the ink is present in the remaining amount detection unit 33, the film inflates and a rotatable lever may contact with this film to be held at a position at which the lever blocks the infrared light, and that, when the ink is absent in the remaining amount detection unit 33, the film may deflate, and the rotatable lever may rotate downward or upward to a position at which the lever does not block the infrared light. In yet another embodiment of the invention, the configuration may be such that the infrared light emitted from the light-emitting element 118 is reflected so as not to reach the light-receiving element 119 in the state in which the ink is present in the remaining amount detection unit 33, and that the infrared light emitted from the light-emitting element 118 is reflected so as to reach the light-receiving element 119 in the state in which the ink is absent in the remaining amount detection unit 33.

As shown in FIG. 3, a portion of the front wall 40 of the body 31 above the remaining amount detection unit 33 may be formed with an opening 34 piecing through the front wall 40 in the depth directions 53, and an air communication port 32 may be positioned closer to the rear wall 42 in the insertion and removal directions 50 than the opening 34. The air communication port 32 may be a through-hole which may pierce through a wall forming the ink chamber 36 in the depth directions 53. Through the air communication port 32, the air space in the ink chamber 36 and the atmosphere external to the ink chamber 36 may be selectively placed in fluid communication.

The air communication port 32 is configured to be selectively openable and closable by an air communication valve 80. If the air communication port 32 is opened, the air pressure in the ink chamber 36, which may be maintained under negative pressure, may equalize to the pressure of the air exterior to the ink cartridge. This air communication port 32 is not necessarily required to be provided on the side of the front wall 40. In another embodiment of the invention, the location of air communication port 32 is not limited as long as the location allows the interior and the exterior of the ink chamber 36 to be selectively placed in fluid communication. Further, in another embodiment of the invention, the ink cartridge 30 may be used with the interior of the ink chamber 36 maintained under negative pressure, and the air communication port 32 may be omitted.

As shown in FIG. 3, an ink supply unit 37 may be positioned at a portion of the front wall 40 of the body 31 below the remaining amount detection unit 33. The ink supply unit 37 may have a substantially cylindrical external shape, and may project outward from the front wall 40 along the insertion and removal directions 50. A projecting end of the ink supply unit 37 may be formed with an ink supply port 71. An ink flow channel 38 may be formed, and ink flow channel 38 may extend in the insertion and removal directions 50 from the ink supply port 71 through the internal space of the ink supply unit 37, to be in fluid communication with the ink chamber 36. The ink supply port 71 may be selectively opened and closed by an ink supply valve 70. As shown in FIG. 6, an ink needle 122 may be positioned at the cartridge installation portion 110. As the ink cartridge 30 is installed into the cartridge installation portion 110, the ink needle 122 may be inserted into the ink supply port 71 to open the ink supply valve 70. After ink supply valve 70 is opened, the ink may flow from the ink chamber 36 through the ink flow channel 38 into the ink needle 122.

The ink supply port 71 is not limited to the configuration openable and closable by the ink supply valve 70. In another embodiment of the invention, for example, the ink supply port 71 may be configured, for example, to be sealed by a film or the like and opened when the ink needle 122 breaks through the film upon installation of the ink cartridge 30 into the cartridge installation portion 110.

A portion of the upper wall 39 of the body 31 near the center thereof in the depth directions 53 may be formed with an engagement portion 43. The engagement portion 43 may be a projection including a planar surface extending in the width directions 51 and the height directions 52 of the ink cartridge 30. The engagement portion 43 may be engaged with a locking lever 145 in the state in which the ink cartridge 30 is installed in the cartridge installation portion 110. Locking lever 145 will be described in more detail herein. In an embodiment of the invention, engagement portion 43 may receive a biasing force for pushing out the ink cartridge 30 in the removal direction 55.

As shown in FIGS. 2 and 3, The body 31 may comprise the first projection 45 and the second projection 46. The first projection 45 may be positioned at the upper end of the front wall 40 of the body 31 to extend from the front wall 40 along a direction away from the rear wall 42, e.g., the installation direction 56, in a direction away from the ink chamber 36. The width of the first projection 45 may be the same as the width of the front wall 40. The first projection 45 may project from the front wall 40 in the direction away from the rear wall 42, e.g., the installation direction 56. The leading end of the first projection 45 may project further in the installation direction 56 than the ink supply port 71 forming the leading end of the ink supply unit 37. In an embodiment, this first projection 45 may have the same width as the width of the front wall 40, but may be formed into a plate shape having a narrower width than the width of the front wall 40. The center in the width directions 51 of the first projection 45 may have a groove 47 formed therein, and groove 47 may extend in the depth directions 53. The groove 47 may be upwardly open in the height directions 52 in the first projection 45. A cross-section of the groove 47 taken along the height directions 52 may have a substantially concave shape. Further, the leading end of the groove 47 in the direction away from the ink chamber 36 may be open.

As shown in FIG. 2, in the internal space of the groove 47, rib 48 may be positioned at the center in the width directions 51 of the bottom surface of the groove 47, with the rib 48 extending in the height directions 52 and the depth directions 53. The rib 48 may stand upward from the bottom surface of the groove 47. In an embodiment of the invention, two opposite side surfaces of the rib 48 in the width directions 51 respectively face and are parallel to a pair of side surfaces of the groove 48 facing each other in the width directions 51. In an embodiment of the invention, the rib 48 may be for blocking or attenuating light traveling in the width directions 51, and may be detected by an optical sensor 116. The distance by which the rib 48 of the first projection 45 projects from the front wall 40 in the direction away from the rear wall 42, e.g., the installation direction 56, may change in accordance with the type of the ink cartridge 30. In an embodiment of the invention, the type of the ink cartridge 30 may refer to, for example, the difference in color or component of the ink, or the difference in amount of the ink initially stored in the ink chamber 36. The rib 48 may correspond to a first detection portion and a first light-blocking portion. The first projection 45 may correspond to a first projecting portion. In an embodiment of the invention, the first projecting portion may be formed by the rib 48.

As shown in FIGS. 2 and 3, the second projection 46 may be positioned at the lower end of the front wall 40 of the body 31. Therefore, the second projection 46 may be positioned below the ink supply unit 37. The width of the second projection 46 may be the same as the width of the front wall 40. The second projection 46 may project from the front wall 40 in the direction away from the rear wall 42, e.g., the installation direction 56. The leading end of the second projection 46 may project further forward in the installation direction 56 than the ink supply port 71 forming the leading end of the ink supply unit 37. In an embodiment of the invention, the distance by which the second projection 46 projects from the front wall 40 in the direction away from the rear wall 42, e.g., the installation direction 56, may be changed in accordance with the type of the ink cartridge 30. The type of the ink cartridge 30 may refer to, for example, the difference in color or component of the ink or the difference in amount of the ink initially accumulated in the ink chamber 36. The second projection 46 may correspond to a second detection portion, a second projecting portion, and a second light-blocking portion. In an embodiment of the invention, the second projection 46 may be indirectly detected in the cartridge installation portion 110.

The detected element 49, which may attenuate or block the infrared light traveling in the width directions 51, may be positioned at the front wall 40 of the body 31 between the first projection 45 and the second projection 46 in the height directions 52 and in front of the remaining amount detection unit 33 in the direction away from the rear wall 42, e.g., the installation direction 56. The detected element 49 may be approximately the same in width as the remaining amount detection unit 33 in the width directions 51. As shown in FIG. 4, this width may have a dimension that allows the detected element 49 to enter between the light-emitting element 118 and the light-receiving element 119 of the optical sensor 114. The detected element 49 may correspond to a third detection portion and a third light-blocking portion. The detected element 49 may be formed by a light-transmissive resin as a part of the remaining amount detection unit 33. In this case, the detected element 49 may have a thickness in the width direction 51 sufficient to attenuate, block, deflect, or reflect, the infrared light. Further, this light-transmissive resin may have a thickness sufficient to attenuate or reflect the infrared light, or may contain a coloring agent.

The detected element 49 and the remaining amount detection unit 33 may be positioned at separate positions from each other, with a predetermined gap formed therebetween in the depth directions 53. In this gap, the infrared light traveling in the width directions 51 may be transmitted without being attenuated to be less than a predetermined amount. The distance of the detected element 49 along the depth directions 53 may be changed in accordance with the type of the ink cartridge 30. In an embodiment of the invention, the type of the ink cartridge 30 may refer to, for example, the difference in color or component, such as pigment or dye, of the ink or the difference in amount of the ink initially accumulated in the ink chamber 36.

Each of the first projection 45, the second projection 46, and the detected element 49 may project further in the direction away from the rear wall 42, e.g., the installation direction 56, than the remaining amount detection unit 33. That is, in the ink cartridge 30, the first projection 45, the second projection 46, and the detected element 49 may be positioned further forward in the installation direction 56 than the remaining amount detection unit 33, and the remaining amount detection unit 33 may be positioned closer to the rear wall 42, e.g., the rear side in the installation direction 56, than the first projection 45, the second projection 46, and the detected element 49. Both of the remaining amount detection unit 33 and the ink supply port 71 may be positioned between the first projection 45 and the second projection 46 in the height directions 52.

As shown in FIG. 2, a guide portion 35 extending in the depth directions 53 may be positioned at the upper wall 39 of the body 31. The guide portion 35 may be formed by a rib or a projecting piece projecting upward from the upper wall 39. The distance between a pair of side walls of the guide portion 35 facing each other in the width directions 51 may be shorter than the distance between a pair of side walls of the body 31 facing each other in the width directions 51. That is, the dimension in the width directions 51 of the guide portion 35 may be less than the dimension in the width directions 51 of the body 31.

As shown in FIG. 2, a guide portion 44 extending in the depth directions 53 may be positioned at the lower wall 41 of the body 31. The guide portion 44 may be formed by a rib or a projecting piece projecting downward from the lower wall 41. The distance between a pair of side walls of the guide portion 44 facing each other in the width directions 51 may be shorter than the distance between a pair of side walls of the body 31 facing each other in the width directions 51. That is, the dimension in the width directions 51 of the guide portion 44 may be less than the dimension in the width directions 51 of the body 31. The guide portions 35 and 44 may be inserted and moved in guide grooves 109 when the ink cartridge 30 is inserted into and removed from the cartridge installation portion 110. Guide grooves 109 will be described in more detail herein.

As shown in FIG. 1, printer 10 may comprise the ink supply device 100. The ink supply device 100 may supply ink to the recording head 21 included in the printer 10. The ink supply device 100 may comprise the cartridge installation portion 110, which may selectively receive at least one ink cartridge, e.g., ink cartridge 30. FIG. 1 shows the state in which the ink cartridge 30 is installed in the cartridge installation portion 110.

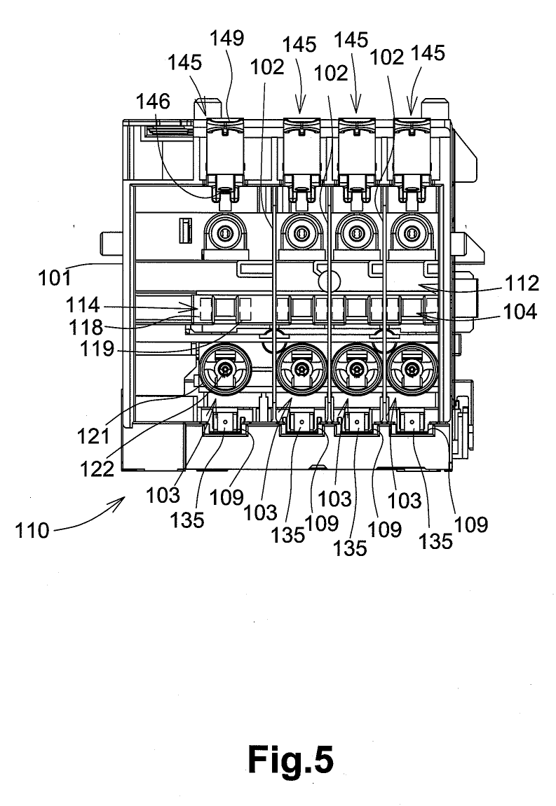

As shown in FIGS. 4 and 5, a case 101 forming a casing of the cartridge installation portion 110 may include the opening 112 formed on the front side of the printer 10 therein. The ink cartridge 30 may be inserted into and removed from the case 101 via the opening 112. The ink cartridge 30 may be guided in the insertion and removal directions 50 as the guide portion 35 is inserted into one of the guide grooves 109. The one of guide grooves 109 to which guide portion 35 may be inserted may be positioned at a ceiling surface defining a ceiling portion of the internal space of the case 101. Guide portion 44 may be inserted into another of the guide grooves 109, which may be positioned at a bottom surface defining a bottom portion of the internal space of the case 101. The case 101 may accommodate a plurality of, e.g., four, ink cartridges 30. In an embodiment of the invention, these ink cartridges 30 correspond to ink cartridges storing respective ink colors of cyan, magenta, yellow, and black.

As shown in FIGS. 4 and 5, the case 101 may comprise three plates 102 for dividing the internal space thereof into four vertically long spaces. The ink cartridges 30 may be accommodated in the respective spaces divided by these plates 102. The plates 102 may be positioned on the side of a terminal surface of the case 101 opposite to the opening 112.

As shown in FIG. 5, connecting portions 103 may be positioned at a lower portion of the terminal surface of the case 101. On the terminal surface, each of the connecting portions 103 may be positioned at a position corresponding to the ink supply unit 37 of the ink cartridge 30 installed in the case 101. In an embodiment, a plurality of, e.g., four, connecting portions 103 may be positioned to correspond to the four ink cartridges 30 which case 101 may accommodate.

Each of the connecting portions 103 may comprise the ink needle 122 and a holding portion 121. The ink needle 122 may be formed by a tubular resin needle. The ink needle 122 may be connected to the ink tube 20 on the side of an external surface which forms the inside and the outside together with the terminal surface of the case 101. The individual ink tube 20 may be drawn to the side of the external surface, which may form the inside and the outside together with the terminal surface of the case 101. The individual ink needle 122 may be pulled upward along the external surface of the case 101, and thereafter may be extended to the recording head 21 of the printer 10 to distribute the ink thereto.

The holding portion 121 may have a substantially cylindrical shape. The ink needle 122 may be positioned at the center of the holding portion 121. As shown in FIG. 6, as the ink cartridge 30 is installed into the cartridge installation portion 110, the ink supply unit 37 may be inserted inside the cylinder of the holding portion 121. In this process, the outer circumferential surface of the ink supply unit 37 may come into close contact with the inner circumferential surface of the cylinder of the holding portion 121. Thereby, the ink supply unit 37 may be inserted into the holding portion 121 with a predetermined gap formed therebetween. As the ink supply unit 37 is inserted into the holding portion 121, the ink needle 122 may be inserted into the ink supply port 71 of the ink supply unit 37. Thereby, the ink stored in the ink chamber 36 may flow to an exterior of the ink chamber 36. The ink flowing from the ink chamber 36 may flow into the ink needle 122. In an embodiment of the invention, the ink needle 122 may correspond to an ink lead-in tube.

As shown in FIGS. 5 and 6, a sensor unit 104 may be positioned at the terminal surface of the case 101, above the connecting portions 103 in the gravity directions. The sensor unit 104 may comprise a substrate 113 and the optical sensor 114. The sensor unit 104 may be configured with the optical sensor 114 installed on the substrate 113. The sensor unit 104 may comprise a plurality of, e.g., four, optical sensors 114. These four optical sensors 114 may correspond to the four ink cartridges 30, which case 101 may accommodate. In an embodiment of the invention, the four optical sensors 114 may be positioned in a line in the width directions of the case 101, e.g., the width directions 51, between the plates 102.

Each of the optical sensors 114 may comprise the light-emitting element 118 and the light-receiving element 119. In an embodiment of the invention, light-emitting element 118 is an LED or other light source. In another embodiment of the invention, light receiving element 119 is a phototransistor or other suitable light collecting or detecting device. The light-emitting element 118 and the light-receiving element 119 may be substantially surrounded by a casing. The optical sensor 114 may have a substantially horseshoe-like external shape formed by the casing. The light-emitting element 118 may emit light from the casing in one direction. The light-receiving element may receive the light emitted to the casing from one direction.

The light-emitting element 118 and light-receiving element 119 may be positioned in the horseshoe-shaped casing such that light-emitting element 118 and light receiving element 119 may face each other, with a predetermined gap formed therebetween. The remaining amount detection unit 33 and the detected element 49 of the ink cartridge 30 may enter the space between the light-emitting element 118 and the light-receiving element 119. When the remaining amount detection unit 33 or the detected element 49 enters the optical path of the optical sensor 114, the optical sensor 114 may detect a change in the transmitted light amount caused by the remaining amount detection unit 33 or the detected element 49, which may block, deflect, or absorb the transmitted light. This optical sensor 114 may correspond to a third sensor. Further, the optical path from the light-emitting element 118 to the light-receiving element 119 in the optical sensor 114 may correspond to a third detection position.

As shown in FIG. 6, a sensor unit 105 may be positioned at terminal surface side of the ceiling surface of the case 101. The sensor unit 105 may comprise a substrate 115 and the optical sensor 116. The sensor unit 105 may be configured with the optical sensor 116 installed on the substrate 115. The sensor unit 105 may comprise a plurality of, e.g., four, optical sensors 116. These four optical sensors 116 ma correspond to the four ink cartridges 30 which the case 101 may accommodate. In an embodiment of the invention, the plurality of, e.g., four, optical sensors 116 may be positioned in a line in the width directions of the case 101, e.g., the width directions 51, between the plates 102.

As the ink cartridge 30 is installed into the case 101, the rib 48 of the first projection 45 may enter the optical path of the optical sensor 116. The installed state of the ink cartridge 30 may be determined by the detection of a change in the signal from the optical sensor 116. Similarly to the optical sensor 114, the optical sensor 116 may comprise a light-emitting element and a light-receiving element, and thus description of a detailed configuration of the optical sensor 116 is be omitted here. In an embodiment of the invention, the optical sensor 116 may correspond to a first sensor. Further, the optical path from the light-emitting element to the light-receiving element in the optical sensor 116 may correspond to a first detection position.

As shown in FIG. 6, a slide member 135 may be positioned at a space 130 formed on the lower end side of a terminal surface of the cartridge installation portion 110. In an embodiment, a plurality of, e.g., four, slide members 135 may be positioned to correspond to the four ink cartridges 30 which case 101 may accommodate. The space 130 may be in fluid communication with the internal space of the cartridge installation portion 110. The slide member 135 may be slidably supported along the insertion and removal directions 50 by a support rod 133 extending along the insertion and removal directions 50 in the space 130. The slide member 135 may have a substantially rectangular parallelepiped external shape. A rib 136 may be positioned at upper end of the slide member 135, and rib 136 may extend along the insertion and removal directions 50. The slide member 135 may be positioned in an insertion path of the second projection 46 of the ink cartridge 30, and may contact the second projection 46. The slide member 135 may correspond to a moving member and a biasing member.

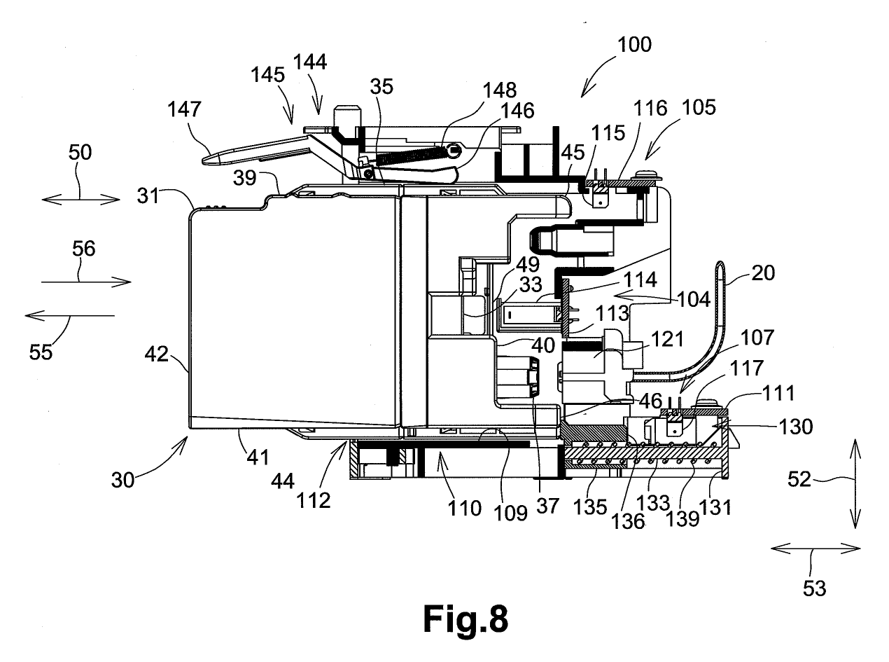

As shown in FIG. 6, coil spring 139 may be positioned in the space 130. The coil spring 139 may elastically bias the ink cartridge 30 to the opening 112 side for the slide member 135, e.g., in the direction in which the ink cartridge 30 is removed from the cartridge installation portion 110, e.g., toward the opening 112. The coil spring 139 may fit onto the support rod 133 extending along the insertion and removal directions 50 in the space 130, and may be interposed between the slide member 135 and a terminal wall 131 defining a terminal end of the space 130. When the coil spring 139 has a length corresponding to when the slide member 135 is not applied with external force, the slide member 135 may be positioned at a predetermined position on the side of the opening 112, e.g., a first position. The first position of slide member 135 is shown in FIG. 8. In the process of insertion of the ink cartridge 30 into the cartridge installation portion 110, the second projection 46 of the ink cartridge 30 may contact with the slide member 135, and the slide member 135 may be pressed toward the terminal wall 131 of the space 130. Thereby, the coil spring 139 is contracted, and the slide member 135 may slide to a position on the side of the terminal wall 131, e.g., a second position. The second position of slide member 135 is shown in FIG. 6. The contracted coil spring 139 biases the ink cartridge 30 in the removal direction 55 via the slide member 135.

As shown in FIG. 6, a sensor unit 107 may be positioned at the terminal surface of the case 101, below the connecting portions 103 in the gravity directions and above the slide members 135 in the gravity directions. The sensor unit 104 may comprise a substrate 111 and the optical sensor 117. The sensor unit 107 may be configured with the optical sensor 117 installed on the substrate 111. The sensor unit 107 may comprise a plurality of, e.g., four, optical sensors 117. The plurality of, e.g., four, optical sensors 117 may correspond to the ink cartridges 30 which case 101 may accommodate. Moreover, the plurality of, e.g., four, optical sensors 117 may correspond to the plurality of slide members 135. The plurality of optical sensors 117 may be positioned in a line in the width directions of the case 101, e.g., in the width directions 51, on the upper side of the space 130.

As the ink cartridge 30 is installed into the case 101, the slide member 135 may slide toward the terminal wall 131 of the space 130, and the rib 136 may enter the optical path of the optical sensor 117, e.g., at a detection position. At the detection position, rib 136 may be detected by the optical sensor 117. Similarly to the optical sensor 114, the optical sensor 117 may comprise a light-emitting element and a light-receiving element, and thus description of a detailed configuration of the optical sensor 117 is be omitted here. In an embodiment of the invention, the optical sensor 117 may correspond to a second sensor. Further, the optical path from the light-emitting element to the light-receiving element in the optical sensor 117 may correspond to a second detection position.

In the cartridge installation portion 110, the detection position of the optical sensor 114, e.g., the third detected position, may be further rearward in the installation direction 56 than both of the respective detection positions of the optical sensors 116 and 117, e.g., the first detection position and the second detection position.

The case 101 may comprise the locking lever 145. The locking lever 145 may maintain the ink cartridge 30 installed in the cartridge installation portion 110 in the installed state, against the biasing force of the coil spring 139. The locking lever 145 may be positioned above the opening 112 of the case 101. In an embodiment, a plurality of, e.g., four, locking levers 145 may be positioned to correspond to the plurality of ink cartridges 30 which case 101 may accommodate.

The entire locking lever 145 may have a substantially arm shape. A support shaft 147 may be positioned at a portion of the locking lever 145 near the center thereof. Support shaft 147 may be supported by the case 101. Thereby, the locking lever 145 may be to be rotatable around the support shaft 147 above the opening 112 of the case 101. The locking lever 145 may be divided into an operation portion 149 and an engaging portion 146. The operation portion 149 may project outward from the opening 112 of the case 101. The operation portion 149 may be subject to the operation for rotating the locking lever 145. The engaging portion 146 may be embedded in the case 101. The engaging portion 146 is configured to be selectively engaged with the engagement portion 43 of the ink cartridge 30. With the engaging portion 146 engaging with the engagement portion 43, the ink cartridge 30, which may be biased by the coil spring 139, may be maintained in an installed position in the case 101. The rotation position of the locking lever 145, at which the engaging portion 146 may engage with the engagement portion 43, may be referred to as a locking position, e.g., a first posture or a first locking position, and the position at which the engaging portion 146 does not engage with the engagement portion 43 may be referred to as an unlocking position, e.g., a second posture or a second locking position. FIG. 6 shows locking lever 145 in the locking position, e.g., the first posture. FIG. 8 shows locking lever 145 in the unlocking position, e.g., the second posture. In an embodiment of the invention, the locking lever 145 may correspond to a locking member.

The locking lever 145 may be attached with a coil spring 148. The locking lever 145 may be biased toward the locking position by the coil spring 148. If the operation portion 149 of the locking lever 145 at the locking position is pushed down in the gravity directions, the locking lever 145 may rotate and transition from the locking position to the unlocking position.

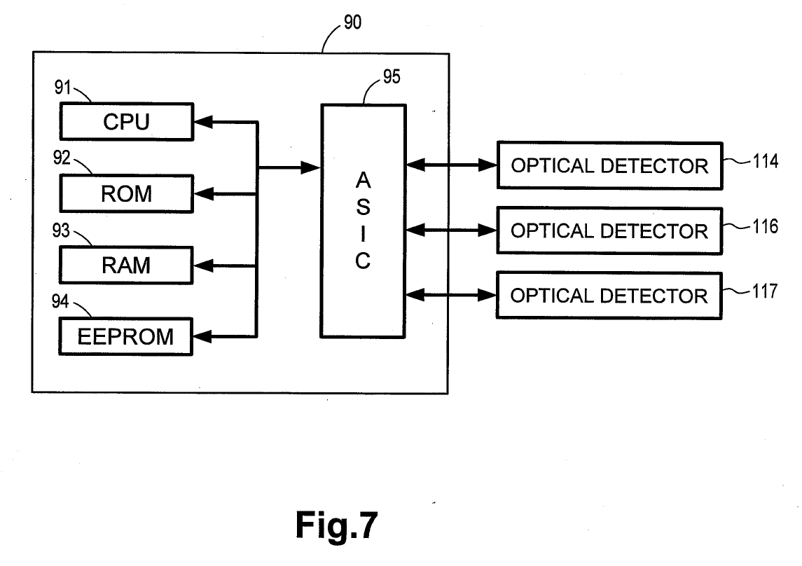

FIG. 7 shows a schematic configuration of a control unit 90 according to an embodiment of the invention. The control unit 90 may control the overall operations of the printer 10. The control unit 90 may comprise a microcomputer, and may comprise one or more of a CPU 91, a ROM 92, a RAM 93, an EEPROM 94, an ASIC 95, and other control components.

The ROM 92 may store a program for causing the CPU 91 to control a variety of operations of the printer 10, a program for performing determination processes described in more detail herein, and the like. The RAM 93 may be used as a storage area for temporarily recording data, signals, and so forth used when the CPU 91 executes the above-described programs, or as a work area for data processing. The EEPROM 94 may store settings, flags, and so forth which may be stored even after the power-off of printer 10. For example, in an embodiment of the invention, the EEPROM 94 may store data, e.g., lookup data, representing the correspondence relationship between the type of the ink cartridge 30 and the combination of output signals of the detected element 49 and the rib 136 of the slide member 135.

The ASIC 95 may be connected to the optical sensors 114, 116, and 117. Although not shown in FIG. 7, the ASIC 95 also may be connected to a drive circuit for driving rollers such as the sheet-feeding roller 23 and the conveying roller pair 25, an input unit for inputting an image recording instruction and so forth to the printer 10, a display unit for displaying information relating to the printer 10, and other components of printer 10.

The optical sensors 114, 116, and 117 may output an analog electrical signal, e.g., a voltage signal or a current signal, according to the intensity of the light received by the light-receiving element. The control unit 90 may monitor, e.g., at a predetermined timing, the electrical signal output from the optical sensors 114, 116, and 117, and may determine the electrical signal to be a HI-level signal if the level, e.g., the voltage value or the current value, of the electrical signal is equal to or greater than a predetermined threshold value. Similarly, the control unit may determine the electrical signal output from the optical sensors 114, 116, and 117 to be a LOW-level signal if the level of the electrical signal is lower than the predetermined threshold value. In an embodiment of the invention, the output signal output when the light is blocked or attenuated at each of the detection positions of the optical sensors 114, 116, and 117 may be determined to be the LOW-level signal, and the output signal output when the light is not blocked or attenuated may be determined to be the HI-level signal. Nevertheless, the determination of the HI-level signal or the LOW-level signal is relative, and thus the type of the output signal corresponding to the level, e.g., threshold value of the electrical signal may be reversed, or changed in other embodiments of the invention.

FIGS. 8-10, show an operation of installing the ink cartridge 30 into the cartridge installation portion 110 according to an embodiment of the invention. Although not shown in the drawings, the opening 112 of the cartridge installation portion 110 may be closed by an openable and closable cover provided to the casing of the printer 10. This cover may be opened when the ink cartridge 30 is installed. In an embodiment of the invention, the opening and closing of the cover may be detected by a sensor. On the basis of a detection signal from this sensor, the control unit 90 may detect that the cover has been opened. Using the opening of the cover as a trigger, the control unit 90 may perform a control such that light may be emitted from the optical sensors 114, 116, and 117.

As shown in FIG. 8, if the ink cartridge 30 is inserted into the cartridge installation portion 110 in the installation direction 56, a guide surface formed at the leading end in the installation direction 56 of the guide portion 35 and tilted forward in the installation direction 56 first may come into contact with the engaging portion 146 of the locking lever 145. If the ink cartridge 30 is further inserted into the cartridge installation portion 110, the engaging portion 146 of the locking lever 145 may ride on the guide portion 35. Thereby, the locking lever 145 may rotate counterclockwise to move from the locking position as shown in FIG. 6, to the unlocking position shown in FIG. 8.

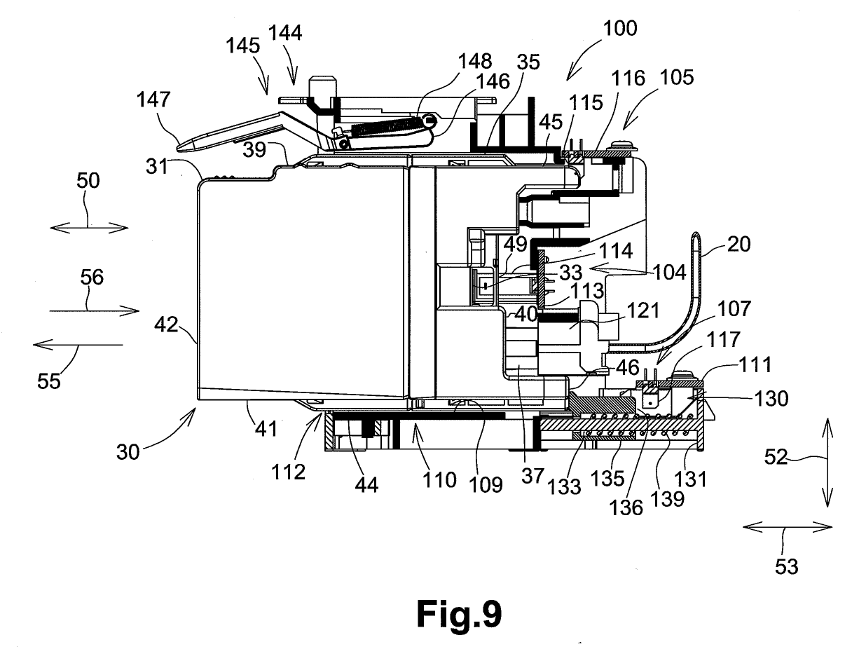

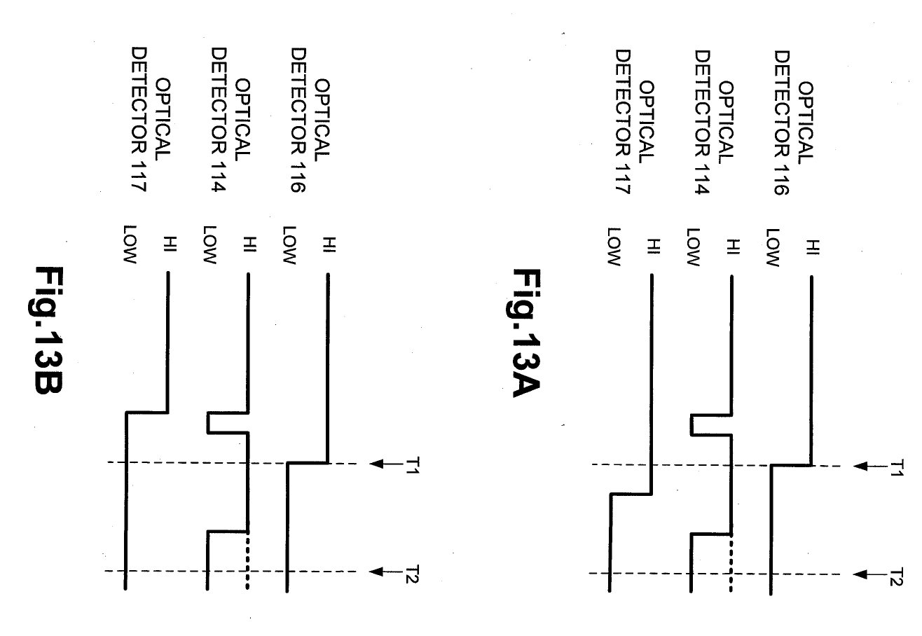

If the ink cartridge 30 is further inserted into the cartridge installation portion 110, the detected element 49 may pass the detection position of the optical sensor 114, e.g., the third detection position, as shown in FIG. 9. When the detected element 49 passes the detection position of the optical sensor 114, as shown in FIG. 9, the remaining amount detection unit 33 may not yet have reached the detection position of the optical sensor 114. As shown in the timing diagrams of FIGS. 13A and 13B, after the detection of the detected element 49 by the optical sensor 114 and before the arrival of the remaining amount detection unit 33 to the detection position of the optical sensor 114, the output signal from the optical sensor 114 may shift from the HI-level signal to the LOW-level signal and then may shift again to the HI-level signal. The control unit 90 may monitor the change in the output signal from the optical sensor 114, and may store a flag indicating that the detected element 49 has been detected, under the condition that the output signal from the optical sensor 114 has shifted from the LOW-level signal to the HI-level signal.

If the ink cartridge 30 is further inserted into the cartridge installation portion 110, the rib 48 of the first projection 45 may enter the detection position of the optical sensor 116, e.g., the first detection position, as shown in FIG. 9. The optical sensor 116 may detect the rib 48, and thereby the output signal from the optical sensor 116 may shift from the HI-level signal to the LOW-level signal, which shift may be shown as timing T1 in FIG. 13A. The control unit 90 may monitor the change in the output signal from the optical sensor 116, and may detect the rib 48 of the first projection 45 on the basis of the output signal being the LOW signal.

The control unit 90 may generate a trigger signal under the condition that the output signal from the optical sensor 116 may shift from the HI-level signal to the LOW-level signal. On the basis of this trigger signal, control unit 90 may perform determination on the output signals from the optical sensors 114 and 117.

In the process of installation of the ink cartridge 30 into the cartridge installation portion 110, the second projection 46 may come into contact with the slide member 135. If the ink cartridge 30 is further inserted into the cartridge installation portion 110, the slide member located at the first position, e.g., as shown in FIG. 8, may be pressed toward the second position, e.g., toward the terminal wall 131 of the space 130 against the biasing force of the coil spring 139. Thereby, the rib 136 of the slide member 135 may approach the detection position of the optical sensor 117, e.g., the second detection position.

As shown in FIG. 9, in an exemplary ink cartridge 30, the rib 136 of the slide member 135 may not yet have reached the detection position of the optical sensor 117 when the output signal from the optical sensor 116 has shifted from the HI-level signal to the LOW-level signal, e.g., when the trigger signal has been generated, e.g., at timing T1. Therefore, the output signal from the optical sensor 117 may be the HI-level signal at timing T1, as shown in FIG. 13A.

The control unit 90 may store the respective output signals from the optical sensors 114 and 117 corresponding to the time of shift of the output signal from the optical sensor 116 from the HI-level signal to the LOW-level signal at timing T1.

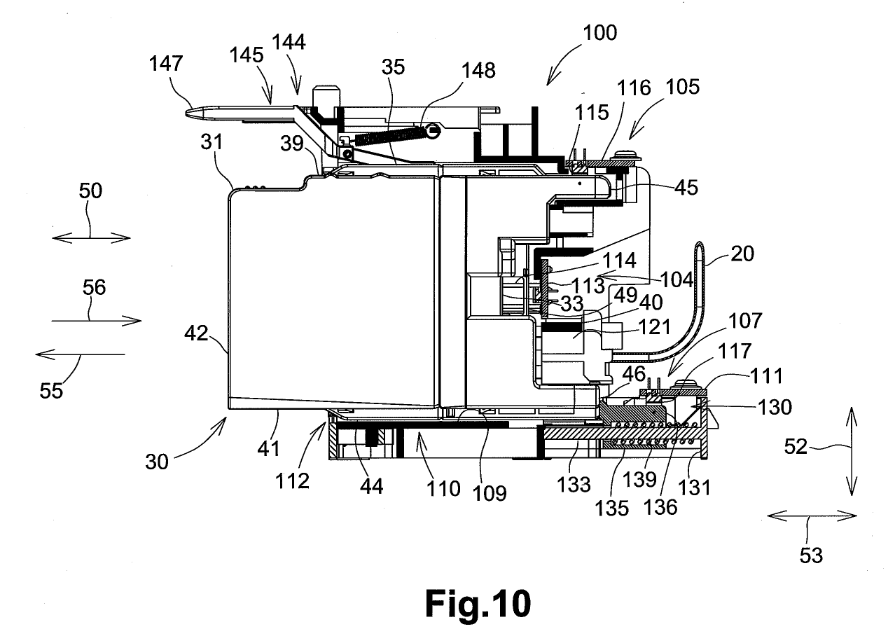

As shown in FIG. 10, if the ink cartridge 30 is further inserted into the cartridge installation portion 110, the rib 136 of the slide member 135 may reach the detection position of the optical sensor 117, e.g., the second detection position. Thereby, the output signal from the optical sensor 117 may shift from the HI-level signal to the LOW-level signal. The control unit 90 may detect the rib 136 of the slide member 135 on the basis of the output signal from the optical sensor 117 being the LOW-level signal.

As shown in FIG. 10, if the ink cartridge 30 is further inserted into the cartridge installation portion 110 and reaches the installation position in the cartridge installation portion 110, the remaining amount detection unit 33 may reach the detection position of the optical sensor 114, e.g., the third detection position. Further, the ink needle 122 may be inserted into the ink supply port 71 of the ink supply unit 37 to open the ink supply port 71. In this installed state, the ink accumulated in the ink chamber 33 may be supplied to the ink tube 20 through the ink needle 122.

When the ink cartridge 30 reaches the installation position, the engagement portion 43 may pass the engaging portion 146 of the locking lever 145 in the installation direction 56. Thereby, the engaging portion 146 of the locking lever 145 may not be supported by the guide portion 35. As a result, the locking lever 145 may rotate clockwise in FIG. 10, and the engaging portion 146 may engage with the engagement portion 43. Because of the engagement between the engaging portion 146 and the engagement portion 43, the ink cartridge 30 may be held at the installation position against the biasing force received from the slide member 135 in the removal direction 55. Thereby, the installation of the ink cartridge 30 into the cartridge installation portion 110 may be completed.

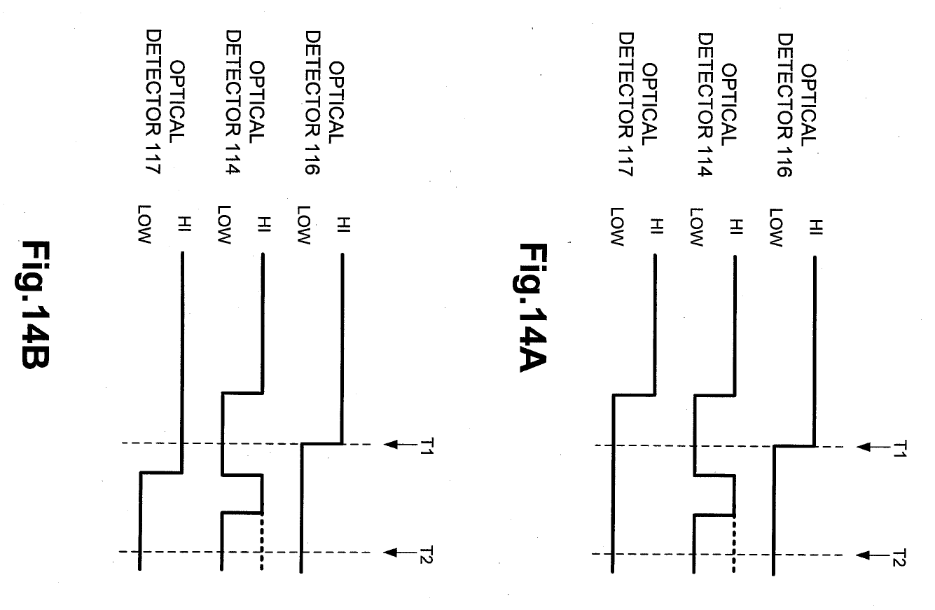

Further, when the ink cartridge 30 reaches the installation position, all of the rib 48 of the first projection 45 and the remaining amount detection unit 33 of the ink cartridge 30 and the rib 136 of the slide member 135 may enter the respective detection positions of the optical sensors 114, 116, and 117, e.g., at timing T2 as shown in FIGS. 13A-13B and 14A-14B. Therefore, if the sensor arm 60 takes the lower posture, the respective output signals from the optical sensors 114, 116, and 117 all may be the LOW-level signal.

The control unit 90 may determine the type of the ink cartridge 30 under the condition that the rib 48 of the first projection 45 and the rib 139 of the slide member 135 have been detected, i.e., under the condition that the respective output signals from the optical sensors 116 and 117 are both the LOW signal. This determination of the type may be performed on the basis of the output signal from the optical sensor 117 and the presence or absence of the flag at the time of shift of the output signal from the optical sensor 116 from the HI-level signal to the LOW-level signal, e.g., at timing T1.

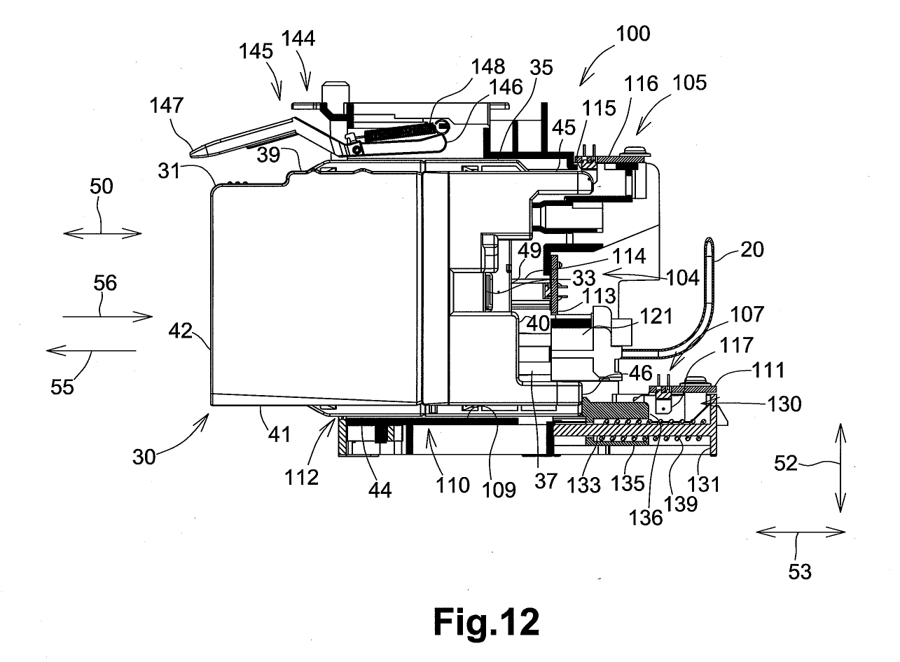

When ink cartridge 30 is an ink cartridge in which the dimension of the detected element 49 along the insertion and removal directions 50 is short, e.g., as shown in FIGS. 9 and 10, the output signal from the optical sensor 114 may shift from the LOW-level signal to the HI-level signal before the shift of the output signal from the optical sensor 116, e.g., at timing T1, as shown in FIGS. 13A-13B. On the basis of this, the flag may be stored in the control unit 90. In contrast, when ink cartridge 30 is an ink cartridge in which the dimension of the detected element 49 along the insertion and removal directions 50 is long, e.g., as shown in FIG. 12, the output signal from the optical sensor 114 may shifts from the LOW-level signal to the HI-level signal after the shift of the output signal from the optical sensor 116, e.g., at timing T1. In this case, the flag may not be stored in the control unit 90, as shown in FIGS. 14A and 14B.

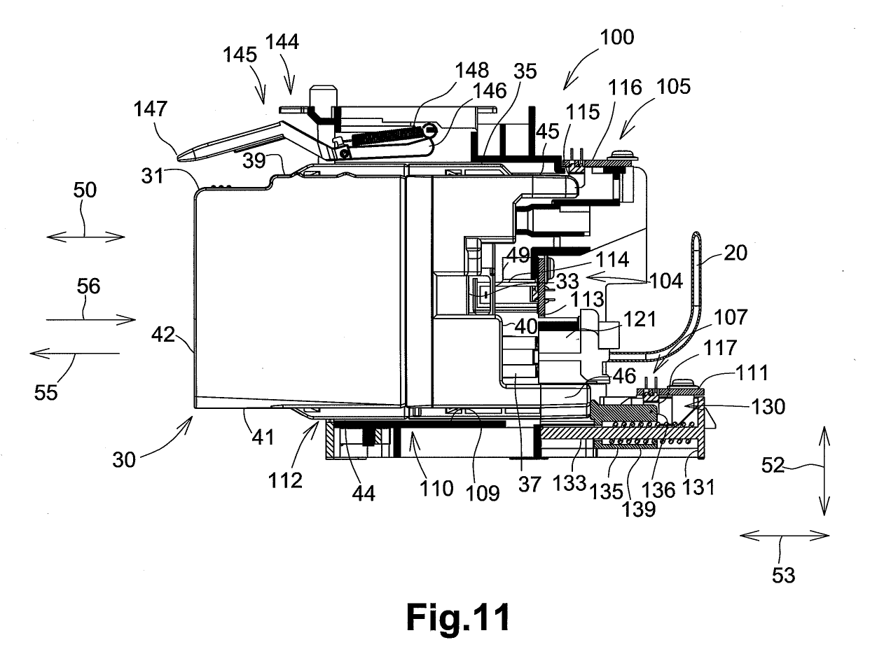

When ink cartridge 30 is an ink cartridge in which the dimension of the projection of the second projection 46 projecting in the installation direction 56 is short, e.g., as shown in FIGS. 9 and 12, the output signal from the optical sensor 117 corresponding to the time of shift of the output signal from the optical sensor 116, e.g., at timing T1, may be the HI-level signal, as shown in FIGS. 13A and 14B. In contrast, when ink cartridge 30 is Meanwhile, in the case of the ink cartridge 30, is an ink cartridge in which the dimension of the projection of the second projection 46 projecting in the installation direction 56 is long, e.g., as shown in FIG. 11, the output signal from the optical sensor 117 corresponding to the time of shift of the output signal from the optical sensor 116, e.g., at timing T1, may be the LOW-level signal, as shown in FIGS. 13B and 14A.

In an embodiment of the invention, the presence or absence of the flag and the output signal from the optical sensor 117 described above may be associated with the type of the ink cartridge 30, and the associations may be stored in the control unit 90 as lookup data. In the ink cartridge 30 shown in FIG. 9, the respective output signals from the optical sensors 114, 116, and 117 correspond to the signal diagram shown in FIG. 13A, and the flag may be stored at the timing T1. Therefore, in an exemplary embodiment of the invention, the control unit 90 may determine that the ink cartridge 30 shown in FIG. 9 stores color ink therein. Further, the output signal from the optical sensor 117 may be the HI-level signal. Therefore, the control unit 90 may determines that the ink cartridge 30 contains a normal amount as the initial ink amount stored in the ink chamber 36.

In the ink cartridge 30 shown in FIG. 11, the respective output signals from the optical sensors 114, 116, and 117 correspond to the signal diagram shown in FIG. 13B, and the flag may be stored at the timing T1. Therefore, in an exemplary embodiment of the invention, the control unit 90 may determine that the ink cartridge 30 stores color ink therein. Further, the output signal from the optical sensor 117 may be the HI-level signal. Therefore, the control unit 90 determines that the ink cartridge 30 contains a large amount of ink, relative to the amount stored in the ink cartridge 30 of FIG. 9, as the initial ink amount stored in the ink chamber 36.

Whether the ink cartridge 30 contains a normal amount or a large amount may be a relative concept. Further, the amount of the ink which may be stored in the ink chamber 36 may vary in accordance with a change in dimension in the width directions 51 of the ink cartridge 30. Further, the normal amount and the large amount may be set in accordance with a change in amount of the ink initially filling ink cartridges 30 including ink chambers 36 having the same dimension in the width directions 51 and the same capacity.

Further, in an embodiment of the invention, the amount of the ink initially filling an ink cartridge 30 packaged together with the printer 10 may be larger than the initial ink amount in a replacement ink cartridge 30. In the printer 10 immediately after the purchase, the tube 20 and the ink flow channel from the tube 20 to the recording head 21 may not be filled with ink. To prevent such an ink flow channel from having a region in which the ink is absent, the program of the control unit 90 is set to perform a purging operation upon initial power-on of the printer 10 after the purchase. The ink cartridge 30 packaged together with the printer 10 thus may be filled with ink increased by the ink amount consumed by this initial suction operation.

In the ink cartridge 30 shown in FIG. 12, the respective output signals from the optical sensors 114, 116, and 117 correspond to the signal diagram shown in FIG. 14A, and the flag may not be stored at the timing T1. Therefore, the control unit 90 may determine that the ink cartridge 30 stores black ink therein. Further, the output signal from the optical sensor 117 may be the LOW-level signal. Therefore, the control unit 90 may determine that the ink cartridge 30 contains a normal amount of ink as the initial ink amount stored in the ink chamber 36.

Further, in the case of the ink cartridge 30 (not shown) having the respective output signals from the optical sensors 114, 116, and 117 as shown in FIG. 14B, the flag may not be stored at the timing T1. Therefore, the control unit 90 may determine that the ink cartridge 30 stores black ink therein. Further, the output signal from the optical sensor 117 may be the HI-level signal. Therefore, the control unit 90 may determine that the ink cartridge 30 contains a large amount of ink, relative to the amount stored in the ink cartridge 30 of FIG. 9, as the initial ink amount stored in the ink chamber 36

As described above, in an embodiment of the invention, if the determination of the type of the ink cartridge 30 determines the color of the ink accumulated in the ink cartridge 30, control unit 90 may determine whether the position in the cartridge installation portion 110, at which the ink cartridge 30 is installed, is the position for color ink. For example, if the control unit 90 determines that black ink is accumulated in the ink cartridge 30 installed at the position in the cartridge installation portion 110, at which an ink cartridge 30 storing color ink should be installed, the control unit 90 may send an error report, on the assumption that the ink cartridge 30 is not installed at an appropriate position. If the control unit 90 determines that the installed ink cartridge 30 is the predetermined type of ink cartridge 30 which should be installed, the control unit 90 may permit the printer 10 to perform an image recording operation.

As described above, if the determination of the type of the ink cartridge 30 determines the amount of the ink accumulated in the ink cartridge 30, the control unit 90 selectively may set the amount of ink droplets which can be discharged from the recording head 21 by the ink cartridge 30, e.g., the count number, or may set the ink amount consumed in the purging operation performed upon initial power-on, depending on whether the initial amount in the ink cartridge 30 installed in the cartridge installation portion 110 is a normal amount or a large amount.

In an embodiment of the invention, the installation of the ink cartridge 30 into the cartridge installation portion 110 may be completed in the above-described manner. In the installation process, the control unit 90 may not detect the remaining amount detection unit 33 on the basis of the output signal from one of the optical sensors 114, 116, and 117 based on the detection of one of the detected element 49, the remaining amount detection unit 33, the rib 48 of the first projection 45, and the rib 136 of the slide member 135. That is, immediately after the installation of the ink cartridge 30 into the cartridge installation portion 110, the control unit 90 may not detect the remaining amount detection unit 33. That the control unit 90 does not detect the remaining amount detection unit 33 refers to that the remaining amount detection unit 33 may not determine the amount of the light received from the remaining amount detection unit 33 on the basis of the output signal from the optical sensor 114, and may be interpreted to include a state in which, even if the optical sensor 114 emits light to the remaining amount detection unit 33 and outputs a signal, the control unit 90 may not make any determination on the basis of the output signal.

Determination of the remaining amount in the ink cartridge 30 will be described below, according to an embodiment of the invention. As shown in FIG. 6, if light is emitted from the light-emitting element 118 of the optical sensor 114 with the ink cartridge 30 installed in the cartridge installation portion 110, the light may be applied to the remaining amount detection unit 33. In a state in which the ink chamber 36 is filled with a predetermined amount or more of ink, the light applied to the remaining amount detection unit 33 may be blocked by the indicator portion 62 of the sensor arm 60. If the ink in the ink chamber 36 is reduced to be less than the predetermined amount, the sensor arm 60 may rotate to prevent the light applied to the remaining amount detection unit 33 from being blocked by the indicator portion 62 of the sensor arm 60. That is, the posture of the sensor arm 60 may change in accordance with the ink amount accumulated in the ink chamber 36, e.g., from the first posture to the second posture, and the light-transmitting state of the remaining amount detection unit 33 may change in accordance with the change in posture of the sensor arm 60. The amount of the light received by the light-receiving element 119 may vary according to whether the light applied by the light-emitting element 118 is blocked by the indicator portion 62, and according to the particular embodiment of the invention and structure of the indicator portion 62.

The light-receiving element 119 may output different electrical signals in accordance with this difference. That is, the optical sensor 114 may output the LOW-level signal, e.g., the outputs from the optical sensor 114 indicated by solid lines in FIGS. 13A-B and 14A-B, if the light applied to the remaining amount detection unit 33 is blocked by the indicator portion 62 of the sensor arm 60, and the optical sensor 114 may output the HI-level signal, e.g., the outputs from the optical sensor 114 indicated by dashed lines in FIGS. 13A-B and 14A-B, if the light applied to the remaining amount detection unit 33 is not blocked by the indicator portion 62 of the sensor arm 60. In an embodiment of the invention, in accordance with such a difference in the electrical signal output from the optical sensor 114, the control unit 90 may determine whether or not the ink in the ink chamber 102 is less than a predetermined amount.

Using, as a trigger, a signal other than the output signals from the optical sensors 114, 116, and 117 generated in the installation process of the ink cartridge 30 described above, the control unit 90 may perform the determination of the remaining amount in the ink cartridge 30, e.g., at timing T2. Further, the control unit 90 may perform the determination of the remaining amount under the condition that the optical sensors 116 and 117 have detected the rib 48 of the first projection 45 and the rib 136 of the slide member 135. When the trigger is generated, control unit 90 may determine whether the optical sensors 116 and 117 have detected the rib 48 of the first projection 45 and the rib 136 of the slide member 135.

In an embodiment of the invention, as the trigger for performing the determination of the remaining amount in the ink cartridge 30, if the printer 10 is provided with a cover having access to the opening 112 of the cartridge installation portion 110 and a sensor for detecting the opening and closing of the cover, for example, the control unit 90 may performs when the cover is closed, the determination of the remaining amount in the ink cartridge 30 on the basis of the output signal from the sensor.

Further, in an embodiment of the invention, the electrical signal serving as the trigger for causing the control unit 90 to perform the determination of the remaining amount in the ink cartridge 30 may be generated when the printer 10 completes the image recording on one page of recording sheet. Further, the electrical signal serving as the trigger may be generated when a cleaning operation of the recording head 21 is completed, when the printer 10 is plugged in, when the power switch of the printer 10 is turned ON, or when the printer 10 in the sleep mode returns to the operating mode, for example.

According to an embodiment of the invention, the detection position of the optical sensor 114, e.g., the third detection position, may be further rearward in the installation direction 56 than the detection position of the optical sensor 116, e.g., the first detection position, and the detection position of the optical sensor 117, e.g., the second detection position, the received light amount of the remaining amount detection unit 33 is detected by the optical sensor 114 after the detection of the rib 48 of the first projection 45 and the rib 136 of the slide member 135 moved by the second projection 46.

Therefore, the rib 48 of the first projection 45, the rib 136 of the slide member 135 moved by the second projection 46, and the remaining amount detection unit 33 can be effectively and accurately detected. Further, the detection position of the remaining amount detection unit 33 is further rearward in the installation direction 56 than the respective detection positions of the optical sensors 116 and 117. Therefore, even if the ink dispersed or leaking from the ink supply port 71 adheres to the first projection 45 and the second projection 46, the ink hardly adheres to the remaining amount detection unit 33 in the operation of inserting or removing the ink cartridge 30 into or from the cartridge installation portion 110.

The detection of the remaining amount detection unit 33 may be performed under the condition that the rib 48 of the first projection 45 and the rib 136 of the slide member 135 moved by the second projection 46 have been detected and the installed state of the ink cartridge 30 has been detected. Therefore, it is possible to secure the time required for the ink adhering to the remaining amount detection unit 33 to be moved downward by gravity and so forth. Further, if a film is used to form the remaining amount detection unit 33, it is possible to secure the time required for the film to inflate after the release of the air in the ink chamber 36. Accordingly, the detection of the remaining amount detection unit 33 may be performed asynchronously with the detection timing of the rib 48 of the first projection 45 and the rib 136 of the slide member 135 moved by the second projection 46.

Further, the optical sensor 114 may detect the detected element 49 in the installation process. Therefore, the rib 48 of the first projection 45, the rib 136 of the slide member 135 may be moved by the second projection 46, the detected element 49, and the remaining amount detection unit 33 may be effectively and accurately detected.

Further, in an embodiment of the invention, the first projection 45 and the second projection 46 may project further in the installation direction 56 than the ink supply port 71. Therefore, if the ink cartridge 30 falls onto the floor or the like or collides with another member, the ink supply port 71 may be prevented from being opened by another member inserted thereinto and causing ink leakage. Similarly, the ink supply port 71 may be prevented from being damaged.

Further, in an embodiment of the invention, the detected element 49 may be positioned separate from the remaining amount detection unit 33 with a space formed therebetween in the installation direction 56. Therefore, the detection of the detected element 49 and the remaining amount detection unit 33 may be achieved by the single optical sensor 114.

In an embodiment of the invention, the remaining amount detection unit 33, the ink supply port 71, the first projection 45, the second projection 46, and the detected element 49 may be located on the front wall 40 of the ink cartridge 30. Therefore, the members required for the linkage between the cartridge installation portion 110 and the ink cartridge 30 may be collected on the front side in the installation direction 56.

In an above-described embodiment, the movement of the slide member 135 provided to the case 101 may be detected by the optical sensor 117. Nevertheless, in another embodiment of the invention, the slide member 135 may not be provided, and the second projection 46 of the ink cartridge 30 may be directly detected by the optical sensor 117. Further, in an above-described embodiment, the detected element 49 may be located further forward in the installation direction 56 than the remaining amount detection unit 33. Nevertheless, in another embodiment of the invention, the detected element 49 may be located above or below the remaining amount detection unit 33 in the height directions 52, as long as the location allows the remaining amount detection unit 33 and the detected element 49 to be detected by different optical sensors.

While the invention has been described in connection with various example structures and illustrative embodiments, it will be understood by those skilled in the art that other variations and modifications of the structures and embodiments described above may be made without departing from the scope of the invention. Other structures and embodiments will be apparent to those skilled in the art from a consideration of the specification or practice of the invention disclosed herein. It is intended that the specification and the described examples are illustrative with the true scope of the invention being defined by the following claims.

What is claimed is:

1. An ink cartridge comprising:
a particular wall;
a particular edge;
an ink chamber configured to store ink therein at the particular wall;
a first detection portion positioned at the particular edge of the ink cartridge;
a second detection portion positioned at the particular edge of the ink cartridge;
a third detection portion extending from the particular wall in a particular direction and positioned between the first detection portion and the second detection portion in a direction perpendicular to the particular direction;
an ink supply portion positioned at the particular wall and configured to supply the ink stored in the ink chamber to an exterior of the ink chamber; and
a remaining amount detection portion positioned at the particular wall between the first detection portion and the second detection portion in the direction perpendicular to the particular direction and configured to transition between a light-transmitting state and a light-blocking state based on an amount of the ink stored in the ink chamber,
wherein each of the first detection portion and the second detection portion is positioned further from the particular edge in the particular direction than the ink supply portion is positioned from the particular edge, and
wherein the third detection portion is positioned further from the particular edge in the particular direction than the remaining amount detection portion is positioned from the particular edge and the third detection portion is positioned closer to the particular edge than the ink supply portion.

2. The ink cartridge according to claim 1, wherein the particular direction is an insertion direction defined as a direction in which the ink cartridge moves during an installation process of the ink cartridge into a cartridge installation portion, and
the ink supply portion is positioned between the first detection portion and the second detection portion in a direction perpendicular to the insertion direction.

3. The ink cartridge according to claim 1 further comprising:
a first projection portion comprising the first detection portion, and the first projection portion extends further from the particular edge in the particular direction than the ink supply portion; and
a second projection portion comprising the second detection portion, and the second projection portion extends further from the particular edge in the particular direction than the ink supply portion.

4. The ink cartridge according to claim 1, wherein
the first detection portion comprises at least one of a light-blocking portion configured to block light and a light-altering portion configured to alter a light path;
the second detection portion comprises at least one of a light-blocking portion configured to block light and a light-altering portion configured to alter a light path;
the third detection portion comprises at least one of a light-blocking portion configured to block light and a light-altering portion configured to alter a light path.

5. The ink cartridge according to claim 1, further comprising a body comprising:
a further wall opposite from the particular wall in a direction opposite to the particular direction;
a third wall extending from a front surface of the particular wall to a rear surface of the further wall;
a fourth wall opposite to the third wall in a direction perpendicular to the particular direction; and
an engagement portion positioned at the third wall, and configured to selectively engage with the locking member to restrain the ink chamber against a biasing force configured to bias the body from the front surface toward the rear surface, when the body is installed in the cartridge installation portion.

6. A recording apparatus comprising:
a cartridge installation portion configured to receive therein an ink cartridge such that the ink cartridge is inserted into the cartridge installation portion in an installation direction;
wherein the cartridge installation portion comprises:
a first sensor configured to output first detection information based on a detection of a first detection portion of the ink cartridge;
a second sensor configured to output second detection information based on a detection of a second detection portion of the ink cartridge; and
a third sensor configured to output third detection based on a detection of a third detection portion of the ink cartridge, and configured to detect a light-transmitting state of a remaining amount detection portion of the ink cartridge and to output fourth detection information based on the light-transmitting state of the remaining amount detection portion, and
control means for performing a first process of determining a type of the ink cartridge based on the first detection information, the second detection information, and the third detection information, and for performing a second process of determining a remaining amount of an ink stored in an ink chamber of the ink cartridge based on the fourth detection information.

7. The recording apparatus according to claim 6 further comprising:
trigger signal output means for outputting a trigger signal based on a particular user operation at a non-ink cartridge portion of the recording apparatus,
wherein the control means performs the second process based on the trigger signal when the first detection portion and the second detection portion have been detected based on the first detection information and the second detection information.

8. The recording apparatus according to claim 6, further comprising control means for, identifying, in the first process, the ink cartridge based on the second detection information and the third detection information when the first detection information is output in an installation process of the ink cartridge into the cartridge installation portion.

9. The recording apparatus according to claim 6, further comprising a moving member configured to contact the second detection portion and to move from a first position to a second position separate from the first position in the installation direction in an installation process of the ink cartridge into the cartridge installation portion,
wherein the second sensor detects a position of the moving member and outputs the second detection information based on the position of the moving member.

10. The recording apparatus according to claim 6, wherein the cartridge installation portion further comprises:
a biasing member configured to bias the ink cartridge in a removal direction opposite to the installation direction, and
a locking member configured to transition between a first locking position and a second locking position, wherein when the locking member is in the first locking position, the locking member is configured to restrain the ink cartridge from moving in the removal direction when the ink cartridge is in an installed state, against the biasing by the biasing member, and when the locking member is in the second locking position, the locking member is configured to allow the biasing member to move the ink cartridge in the removal direction.

11. The recording apparatus according to claim 10, wherein the locking member is configured to selectively engage with an engagement portion positioned at a particular surface of the ink cartridge in the installed state.

12. The recording apparatus according to claim 6, wherein the cartridge installation portion further comprises an ink lead-in tube extending along the installation direction and configured to be inserted into an ink supply port of an ink supply portion of the ink cartridge.
